(19) United States
(12) Patent Application Publication
(10) Pub. No.: US 2010/0171481 A1
(43) Pub. Date: Jul. 8, 2010

(54) DIGITAL POWER CONTROL DEVICE

(76) Inventor: Da-Yi Liu, Taipei (TW)

Correspondence Address: Da-Yi Liu, 235 Chung - Ho Box 8-24 Taipei, Taiwan, R.O.C., Taipei, 235, TW

(21) Appl. No.: 12/350,234

(22) Filed: Jan. 8, 2009

(51) Int. Cl. G05F 1/10

(52) U.S. Cl. 323/283

(57) ABSTRACT

A digital power control device includes a power input terminal, power converter, regulator, power output terminal, feedback voltage detecting unit, feedback voltage encoder, PWM control unit, and a digital PWM output module 8. The feedback voltage encoder includes at least a resistor array, switch array, a resistor, a first comparator, and a second comparator. The feedback voltage encoder will provide a compare signal by processing the comparison between a feedback voltage detected by the feedback voltage detecting unit and a predetermined reference voltage. The PWM control unit will provide a control signal by processing the above compare signal. The digital PWM output module will control the DC converter to produce an analog pulse train with required duty cycle by the control signal of the PWM control unit so that the power output terminal can provide proper power to the electric equipment connected.

### FIELD OF THE PRESENT INVENTION

The present invention relates to power control device, and particular to a digital power control device capable of adjusting and providing a steady current.

### DESCRIPTION OF THE PRIOR ART

For functional operating an electric device, a steady and proper power supply to the electric device is needed. Such proper voltage and current supply will protect and prolong a life time of the device and also save energy. A power control device arranged between power source and power input terminal of the electric device is thus presented to adjust a proper power to the electric device. As shown in FIG. 4, a known power control device based on pulse width modulation (PWM) mainly includes a voltage regulating unit controlling a power converter to adjust output power. The voltage regulating unit has a predetermined reference voltage which normally set as 0.5 to 20 volt. The voltage regulating unit further includes a comparator connected to the reference voltage and an output end of a detecting circuit. The comparator will detect a difference between the reference voltage Vref and a feedback voltage Vfb detecting by the detecting circuit. A signal Verr of the error voltage is generated to represent which one of the reference voltage Vref and the feedback voltage Vfb is larger. The signal Verr is provided to a PWM control unit. By the signal Verr generated by the comparator according to magnitudes of the reference voltage Vref and the feedback voltage Vfb, the power converter is controlled by the PWM control unit to produce a proper power to the electric device. However, because of errors of the resistors, reference voltage, and circuit loss, the prior power control device can not precisely control output power with a highest precision of 2 to 2.5%. It is also disturbed that relative components modifications are needed for changing output power. For the precision of the output power, digital voltage regulating unit is applied on some power control devices such as a U.S. Pat. No. 6,995,995 (Digital loop for regulating DC/DC converter with segmented switching). An analog feedback signal of a detecting circuit is transformed by an analog/digital converter. The transformed digital signal will be calculated to produce a control signal. A switch array consists of a plurality of MOS-FETs will be controlled by the control signal to adjust output power. The analog/digital converter and the MOS-FET are expensive components, it is also a difficult problem to solve of such power control device.

### SUMMARY OF THE PRESENT INVENTION

Accordingly, a primary object of the present invention is to provide a convenient digital power control device capable of adjusting output power by changing settings of a memory unit, unlike an external circuits or component modifications of a prior power control device.

A secondary object of the present invention is to provide a digital power control device capable of accurately supplying power with an error less than 0.5% by a precisely duty cycle control of a digital PWM output module.

Another object of the present invention is to provide a digital power control device with a memory unit capable of storing product identifications and operation records for further management and debugging.

The various objects and advantages of the present invention will be more readily understood from the following detailed description when read in conjunction with the appended drawing.

### BRIEF DESCRIPTION OF THE DRAWINGS

FIG. 1 is a block diagram showing functions of a preferable embodiment of the present invention.

FIG. 2 is a circuit diagram of a feedback voltage encoder of the embodiment of the present invention.

FIG. 3 is a waveform diagram of input and output of a comparator of the embodiment of the present invention, and

FIG. 4 is a block diagram showing functions of a prior digital power control device.

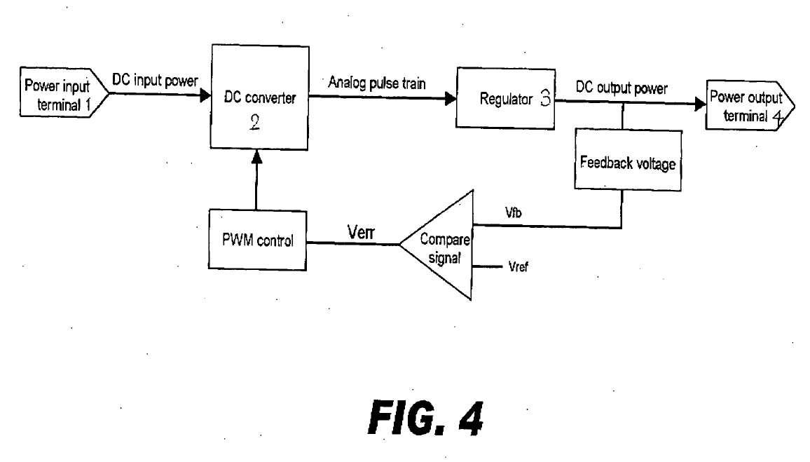

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

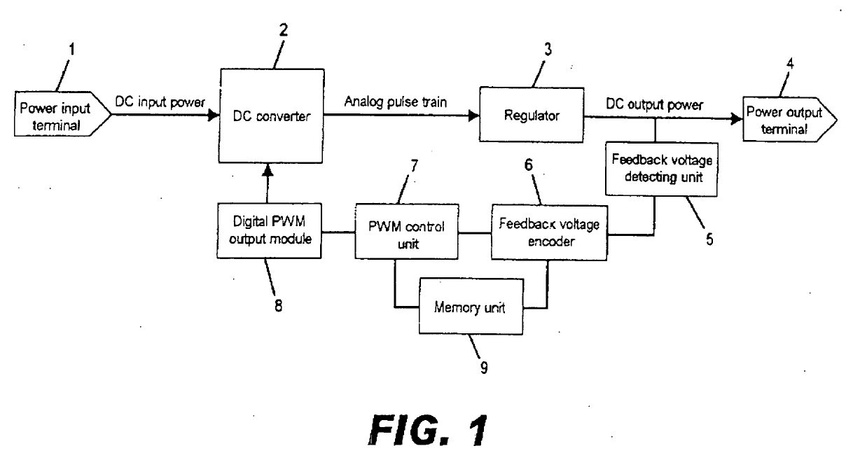

Referring to FIG. 1, a block diagram showing functions of a preferable embodiment of the present invention is illustrated. A digital power control device according to the present invention includes a power input terminal 1, DC converter 2, regulator 3, power output terminal 4, feedback voltage detecting unit 5, feedback voltage encoder 6, PWM control unit 7, digital PWM output module 8, and a memory unit 9. The power input terminal 1 provides a DC power. The DC converter 2 transforms the DC power into an analog pulse train. The regulator 3 transforms the analog pulse train into DC output power. The power output terminal 4 connects and supplies power to a load or an electric equipment. The feedback voltage detecting unit 5 connected to a node of the power output terminal 4 provides a feedback voltage Vfb. The feedback voltage encoder 6 composed of a resistor array, switch array, at less two comparators will provide a compare signal by processing the comparison between above Vfb and a predetermined reference voltage. The PWM control unit 7 composed of a plurality of registers, adders, dividers, counters, and logic gates will provide a control signal by processing the compare signal from the feedback voltage encoder 6. The digital PWM output module 8 is a digital PWM controller which adjusts duty cycle of the output of the DC converter 2 by the control signal of the PWM control unit 7 so that the power output terminal 4 can provide proper power to the electric equipment connected. The memory unit 9 can store the feedback voltage of the feedback voltage detecting unit 5, the compare signal of the feedback voltage encoder 6, and the control signal of the PWM control unit 7.

While the digital power control device is operating, DC power is supplied from the power input terminal 1 to the DC converter 2 and passes through the regulator 3 in form of an analog pulse train. The power output terminal 4 will provide DC power to electric device. The power output terminal 4 will also provide power to the feedback voltage detecting unit 5. The feedback voltage detecting unit 5 will provide the feedback voltage Vfb to the feedback voltage encoder 6. The feedback voltage encoder 6 will prepare and process the above Vfb with a high reference voltage Vref+ and a low reference voltage Vref− and will provide compare signal samples to the PWM control unit 7. The samples will be calculated by the PWM control unit 7 and a proper control signal will be calculated and provided to the digital PWM output module 8. The DC converter 2 is adjusted by the digital PWM output module 8 according to the control signal so as to supply a steady power to the electric device. When a load being connected to the power output terminal 4 is changed, above operations will provide a new steady power to the load. Moreover, the feedback voltages, compare signals, and control signals stored in the memory unit 9 are records for further management, debugging, and tracing.

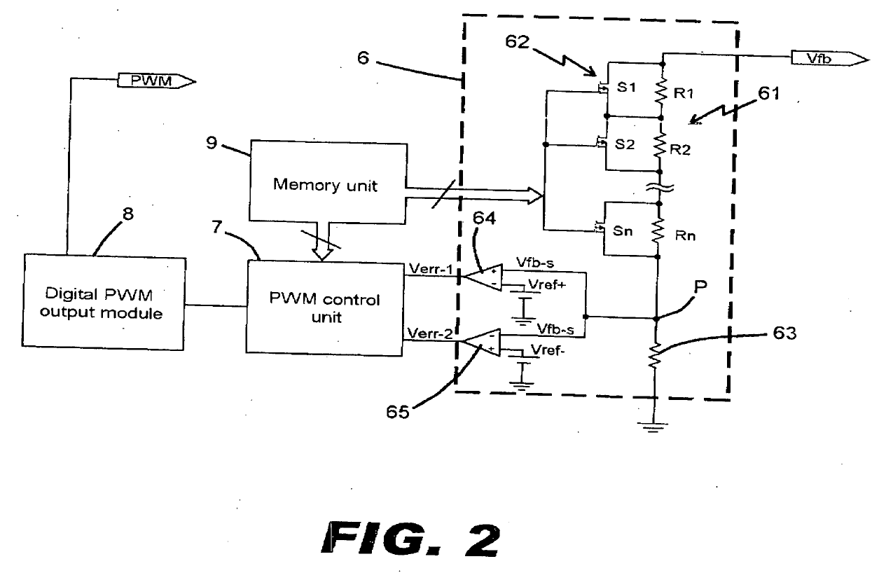

With reference to FIG. 2, a preferable embodiment of a circuit of the feedback voltage encoder 6 is illustrated. The feedback voltage encoder 6 includes at least a resistor array 61, switch array 62, resistor 63, first comparator 64, and a second comparator 65. The resistor array 61 is serial linked by a plurality of resistors including R1, R2, . . . , Rn. Resistances of the resistors are decreased from 4 kohm of the R1 to 5 ohm of the Rn. The switch array 62 has a plurality of switches including S1, S2, . . . , Sn. The number of the switches of the switch array 62 matches the number of the resistors of the resistor array 61. The switch S1 is parallel linked to the resistor R1, the switch S2 is parallel linked to the resistor R2. In the same way, the switches are respectively parallel linked to the relative resistors. The resistor 63 is connected the resistor Rn and switch Sn which is an output end of the arrays to a ground. The first comparator 64 is connected to the high reference voltage Vref+ and a node P between the resistor 63 and the resistor Rn and the switch Sn, the high reference voltage Vref+ is 101% the voltage of the predetermined reference voltage. The first comparator 64 will compare the difference between the high reference voltage Vref+ and the voltage Vfb-s of the node P and generate an error voltage Verr-1 represented which one of the Vref+ and the Vfb-s is larger to the PWM control unit 7. The second comparator 65 is connected to the low reference voltage Vref− and the node P between the resistor 63 and the resistor Rn and the switch Sn, the low reference voltage Vref− is 99% the voltage of the predetermined reference voltage. The second comparator 65 will compare the difference between the low reference voltage Vref− and the voltage Vfb-s of the node P and generate an error voltage Verr-2 represented which one of the Vref− and the Vfb-s is larger to the PWM control unit 7. While operating, the feedback signal Vfb of the feedback voltage detecting unit 5 is conducted to the resistor R1 and the switch S1 and through the error voltage Verr-1 and Verr-2 of the comparator 64 and 65 to the PWM control unit 7.

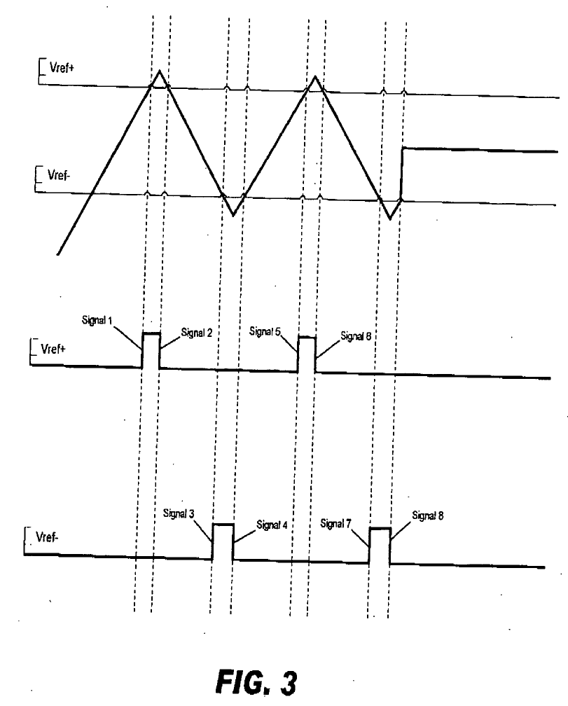

Furthermore, input and output waveforms of the comparator of the feedback voltage encoder 6 are shown in FIG. 3. An upper waveform is the feedback voltage Vfb of the feedback voltage detecting unit 5. A middle one is the error voltage Verr-1 of the comparator 64 and a low one is the error voltage Verr-2 of the comparator 65.

During initial operating, the PWM duty of the PWM control unit 7 is getting larger from 1%, also the feedback voltage is getting larger as the upper waveform of the FIG. 3. When the feedback voltage is larger than the high reference voltage Vref+ which is 101% the voltage of the predetermined reference voltage, a signal 1 (the middle waveform in the FIG. 3) will be generated so that the PWM control unit 7 will be triggered to lower the PWM power. The duty cycle of the analog pulse train of the DC converter 2 will be lowered as well as the output power of the power output terminal 4. While the feedback voltage is lowered below the high reference voltage Vref+, a signal 2 (the middle waveform in the FIG. 3) will be generated and the memory unit 9 will record the PWM power at the time. The feedback voltage will keep dropping and reach the low reference voltage Vref− which is 99% the voltage of the predetermined reference voltage, a signal 3 (the lower waveform in the FIG. 3) will be generated so that the PWM control unit 7 will be triggered to increase the PWM power. The duty cycle of the analog pulse train of the DC converter 2 will be increased as well as the output power of the power output terminal 4. While the feedback voltage is increased above the low reference voltage Vref−, a signal 4 (the lower waveform in the FIG. 3) will be generated and the memory unit 9 will record the PWM power at the time. In the same way, signals 5, 6, 7, 8 will also be generated. The signals 1, 3, 5, 7 are triggered for reversing voltage ramp, and the signals 2, 4, 6, 8 are triggered for recording the instant voltages. When such voltage records are enough, the adder and divider of the PWM control unit 7 will calculate a proper PWM power and provide a signal to the digital PWM output module 8. The DC converter 2 will provide the analog pulse train with proper duty cycle and the power output terminal 4 will supply steady and fixed power to the load. However, when the load is changed, a new steady voltage will be provided by above operations.

Therefore, through the precise duty cycle control of the analog pulse train of the DC converter 2 by the digital PWM output module 8, an accurate power required with an error within 0.5% will be provided. Also, it is easy to modify output power by changing the setting of the memory unit, circuit and other components modification is not required. Moreover, the operation records and product identifications stored in the memory unit can be used for further management, debugging, and tracing.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A digital power control device comprising:
a power input terminal for a DC power input;
a DC converter transforming the DC power into a analog pulse train;
a regulator transforming the analog pulse train into a DC power output;
a power output terminal supplying the transformed DC power to a load;
a feedback voltage detecting unit connected to a node of the power output terminal and providing a feedback voltage;
a feedback voltage encoder comparing the feedback voltage with a reference voltage and providing a compare signal;
a PWM control unit calculating and providing a control signal according to the compare signal; and
a digital PWM output module adjusting the DC converter to produce the analog pulse train with a required duty cycle according to the above control signal.

2. The digital power control device as claimed in claim 1, wherein the feedback voltage encoder further comprises at least:
a resistor array having a plurality of serial linked resistors, the resistors being arranged with gradually decreased resistances within a predetermined range;
a switch array having switches with the same quantities of the above resistor array, the switches being parallel linked to the resistors respectively;
a resistor connecting the resistor array and the switch array to a ground;
a first comparator having two input terminals being respectively connected to a high reference voltage Vref+ and a node between the resistor, switch array and the resistor, an output thereof being connected to the PWM control unit; and
a second comparator having two input terminals being respectively connected to a low reference voltage Vref− and the node between the resistor, switch array and the resistor, an output thereof being connected to the PWM control unit.

3. The digital power control device as claimed in claim 2, wherein the range of the resistances of the resistors is within 4K to 10 ohm.

4. The digital power control device as claimed in claim 2, wherein the switches are Metal-Oxide-Semiconductor Field-Effect Transistors (MOSFET).

5. The digital power control device as claimed in claim 2, wherein the high reference voltage Vref+ is 101% the voltage of the predetermined reference voltage.

6. The digital power control device as claimed in claim 2, wherein the low reference voltage Vref− is 99% the voltage of the predetermined reference voltage.

7. The digital power control device as claimed in claim 1 further comprising a memory unit recording at least the compare signals of the feedback voltage encoder and the control signals of the PWM control unit.
